(19) United States
(12) Patent Application Publication
(10) Pub. No.: US 2010/0130352 A1
(43) Pub. Date: May 27, 2010

(54) Methods For Processing Shaped Bodies

(76) Inventors: Leonard Charles Dabich, II, Painted Post, NY (US); James Gerard Fagan, Painted Post, NY (US); Kishor Purushottam Gadkaree, Big Flats, NY (US); Millicent Odei Owusu, Painted Post, NY (US); Mallanagouda Dyamanagouda Patil, Corning, NY (US)

Correspondence Address: CORNING INCORPORATED, SP-TI-3-1, CORNING, NY, 14831, US

(21) Appl. No.: 12/367,049

(22) Filed: Feb. 6, 2009

Related U.S. Application Data
(60) Provisional application No. 61/117,772, filed on Nov. 25, 2008.

(51) Int. Cl. B01J 20/00; B01J 32/00; F27D 7/00

(52) U.S. Cl. 502/400; 502/439; 432/9; 432/14; 432/18

(57) ABSTRACT

The present disclosure relates to methods of making shaped bodies comprising providing a substantially uniform temperature and gas flow throughout the shaped body as a function of reaction time. The disclosure further relates to methods of making shaped bodies substantially uniformly oxidized. The methods comprise setting at least one shaped body and performing at least one firing of the at least one shaped body. The present disclosure further relates to shaped bodies made according to the methods disclosed.

### CROSS-REFERENCE TO RELATED APPLICATION

This application claims the benefit of priority to U.S. Provisional Application No. 61/117,772, filed on Nov. 25, 2008.

### FIELD

Disclosed herein are methods of processing shaped bodies, such as carbon-based, inorganic cements, or ceramic bodies, comprising providing a substantially uniform temperature and gas flow throughout the shaped body as a function of reaction time. The present disclosure further relates to methods of making shaped bodies substantially uniformly oxidized comprising controlled oxidation of the shaped body by providing a substantially uniform temperature and gas flow throughout the shaped body as a function of reaction time, and shaped bodies made according to the methods of the invention.

### BACKGROUND

Shaped bodies, including high surface area structures, may be used in a variety of applications. Such bodies may be used, for example, as supports for catalysts for carrying out chemical reactions or as sorbents/filters for the capture of particulate, liquid, or gaseous species from fluids such as gas streams and liquid streams. As an example, certain activated carbon bodies, such as honeycombs, may be used as catalyst substrates or for the capture of heavy metals from gas streams. For example, certain ceramic bodies may also be used as catalyst substrates or for the capture of particulates such as soot.

Shaped bodies may be manufactured by first subjecting an unprocessed or “green” shaped body to one or more heat treatments, and/or then subsequently subjecting the treated shaped body to one or more controlled oxidation firings. Providing a substantially uniformly oxidized shaped body with substantially uniform physical strength may be important to long term performance of the shaped body.

The inventors have now discovered methods for heat treatment and/or controlled oxidation of shaped bodies, which may provide a substantially uniform temperature and gas flow throughout the shaped body as a function of reaction time. In at least one embodiment, the substantially uniform temperature and gas flow may be achieved through use of a configuration comprising a box diffuser and protection of the exposed surfaces of the shaped body. In another embodiment, the substantially uniform temperature and gas flow throughout the shaped body may be achieved by control of the ramp temperature and gas flow during the processing. Setters and/or cookies, ceramic felt, and other devices may also be used in various exemplary embodiments of the invention. The resulting shaped bodies may, in at least certain embodiments, have substantially higher surface areas and uniformity, and fewer physical defects than shaped bodies made according to procedures currently known in the art.

### SUMMARY

In accordance with the detailed description and various exemplary embodiments described herein, the present disclosure relates to methods for heat treatment and/or controlled oxidation of shaped bodies. In various exemplary methods of the present disclosure, controlled oxidation achieves substantially uniform oxidation throughout the channel length and shaped body. Exemplary methods include providing substantially uniform temperature and gas flow throughout the shaped body as a function of process (either heat treatment or controlled oxidation) time. Uniform flow may, in certain exemplary embodiments, be achieved through use of a box diffuser and protection of exposed shaped body surfaces and/or control of the ramp temperature and gas flow during the firing to produce samples with substantially uniform oxidation or activity. Setters, cookies, ceramic felt, and/or other devices may also be used in various exemplary embodiments.

The present disclosure also relates to methods for making shaped bodies having substantially uniform oxidation comprising providing a substantially uniform temperature and gas flow throughout the shaped body as a function of reaction time. In various exemplary embodiments, the disclosure relates to methods of making ceramic, inorganic cement, or carbon-based shaped bodies having substantially uniform activity comprising optionally carbonizing and activating the ceramic, inorganic cement, or carbon-based shaped body. The present disclosure further relates to shaped bodies made according to any of the methods of the invention. In various exemplary embodiments, the shaped body may be a monolithic structure comprising channels or porous networks permitting the flow of process gas through the monolith, for example, but not limited to, honeycomb shaped bodies comprising an inlet end, an outlet end, and a multiplicity of cells extending from one end to the other, wherein the cells are defined by intersecting cell walls. In at least one additional exemplary embodiment, the shaped body may be a ceramic, inorganic cement, or carbon-based body, for example, a honeycomb body.

As used in the present disclosure, the term “shaped body,” and variations thereof, is intended to include ceramic, inorganic cement, and/or carbon-based bodies. Ceramic bodies include, but are not limited to, those comprised of cordierite and silicon carbide. Inorganic cement bodies include, but are not limited to, those comprised of inorganic materials comprised of an oxide, sulfate, carbonate, or phosphate of a metal, including calcium oxide, calcium aluminate cements, calcium/magnesium sulfate cements, and calcium phosphate. Carbon-based materials include, but are not limited to, synthetic carbon-containing polymeric material (which may be cured or uncured); activated carbon powder; charcoal powder; coal tar pitch; petroleum pitch; wood flour; cellulose and derivatives thereof; natural organic materials, such as wood flour, nut-shell flour; starch; coke; coal; or mixtures thereof. In some embodiments, the carbon-based material comprises a phenolic resin or a resin based on furfuryl alcohol.

As used herein, “substantially uniform temperature and gas flow,” and variations thereof, means the inlet and outlet gas temperature and inlet and outlet rate of gas flow are substantially similar to one another.

As used herein, “substantially uniformly oxidized” and “substantially uniform oxidation,” and variations thereof, means the shaped body is free of cracks and has substantially uniform surface area throughout. Whether the surface area is substantially uniformly oxidized or substantially similarly oxidized is well within the ability of those skilled in the art to determine.

As used in the present disclosure, the terms “process gas,” “process gases,” “process atmosphere,” and variations thereof, are intended to mean oxidizing and inert gases, mixtures thereof, and any other gas or atmosphere that may exist or flow through the furnace and/or furnace chambers in the presently disclosed methods.

As used in the present disclosure, the terms “inert gas,” “inert atmosphere,” and variations thereof, are intended to mean process gases and/or atmospheres comprising at least one inert gas, such as, but not limited to, nitrogen, helium, and argon.

As used in the present disclosure, the terms “oxidizing gas,” “oxidation gas,” “oxidizing atmosphere,” and variations thereof, are intended to mean process gases and/or atmospheres comprising at least one gas containing oxygen species. Examples of oxidizing gases include, but are not limited to carbon dioxide and steam.

Additional objects and advantages of the invention are set forth in the following description. Both the foregoing general summary and the following detailed description are exemplary only and are not restrictive of the invention as claimed. Further features and variations may be provided in addition to those set forth in the description. For instance, the present invention includes various combinations and subcombinations of the features disclosed in the detailed description. In addition, it will be noted that the order of the steps presented need not be performed in that order in order to practice the invention.

### BRIEF DESCRIPTION OF THE DRAWINGS

The accompanying drawings are included to provide a further understanding of the invention, and are incorporated in and constitute a part of this specification. The drawings are not intended to be restrictive of the invention as claimed, but rather illustrate embodiments of the invention and, together with the description, serve to explain the principles of the invention.

FIG. 1 shows an example of a setter configuration in preparation for firing a shaped body in accordance with at least one exemplary embodiment.

FIG. 2A depicts detailed surface area mapping for the 8″×8″×2″ activated sample of Example 1.

FIG. 2B depicts a core sample take from the shaped body of Example 1.

FIG. 3 depicts the surface areas obtained for the points mapped in FIG. 2A.

FIG. 4 depicts detailed surface area mapping for the 8″×8″×3″ activated samples of Example 2.

FIG. 5 depicts the surface areas obtained at the points mapped in FIG. 4 for each of the three samples.

FIG. 6 depicts the surface areas measured at three points (top, middle, and bottom) of the center cores described according to one embodiment of the disclosure, as described in Example 2.

FIG. 7 depicts the surface areas measured at four points (top, middle 1, middle 2, and bottom) of the center core and front core of the shaped body according to one embodiment of the disclosure, as described in Example 3.

FIG. 8 depicts the surface areas measured at three points (top, middle, and bottom) of the center core for two of the shaped bodies according to one embodiment of the invention as described in Example 3.

FIG. 9 depicts the burn off on activation (“BOA”) for each oxidation cycle, i.e., activation cycle, of the exemplary shaped bodies according to Example 4 as a function of the carbon dioxide/nitrogen ratio of the reaction gas.

### DETAILED DESCRIPTION

It is to be understood that both the foregoing general description and the following detailed description are exemplary and explanatory only, and are not restrictive of the invention as claimed. Other embodiments of the invention will be apparent to those skilled in the art from consideration of the specification and practice of the invention disclosed herein. It is intended that the specification and examples be considered as exemplary only, with a true scope and spirit of the invention being indicated by the claims.

The present disclosure relates to methods for achieving substantially uniform oxidation of shaped bodies comprising providing a substantially uniform temperature and gas flow throughout the shaped body as a function of reaction time. For example, in one embodiment where the shaped body is a ceramic, inorganic cement, or carbon-based body, such as a honeycomb body, the substantially uniform oxidation may be achieved throughout the channel length and substrate width. At least one exemplary embodiment comprises preparing at least one shaped body for firing, and firing said shaped body, wherein said firing comprises providing a substantially uniform temperature and gas flow throughout the shaped body as a function of reaction time. In a further exemplary embodiment, methods for heat treatment and/or controlled oxidation of at least one shaped body comprise setting at least one shaped body and performing at least one uniform firing of the at least one shaped body. Managing flow of both gases and thermal energy substantially uniformly, and keeping the concentration of oxidizing gases substantially uniform throughout the shaped body, may, in various exemplary embodiments, achieve substantial uniformity of the shaped body. Uniform flow may, in certain exemplary embodiments, be achieved through use of a box diffuser and protection of exposed shaped body surfaces and/or control of the ramp temperature and gas flow during the firing.

In at least one additional exemplary embodiment, the shaped body is a ceramic, inorganic cement, or carbon-based body, and the method comprises preparing at least one ceramic, inorganic cement, or carbon-based body for firing, and firing said ceramic, inorganic cement, or carbon-based body, wherein said firing comprises providing a substantially uniform temperature and gas flow throughout the ceramic, inorganic cement, or carbon-based body as a function of reaction time. In a further exemplary embodiment, methods for heat treatment and/or controlled oxidation comprise carbonization and/or activation of at least one ceramic, inorganic cement, or carbon-based body. In at least one additional exemplary embodiment, the methods comprise heat treatment and/or oxidation of at least one honeycomb shaped body, wherein the process gas flows through the multiplicity of cells or channels of the honeycomb body from the inlet end to the outlet end.

Heat treatments, as described herein, may include, for example, carbonization, which is a process that involves the thermal decomposition of the carbonaceous material in a ceramic or carbon-based shaped body, thereby eliminating low molecular weight species (e.g., carbon dioxide, water, and gaseous hydrocarbons) and producing a fixed carbon mass and a rudimentary pore structure in the shaped body. Traditionally, during carbonization, a ceramic or carbon-based shaped body is heated to a high temperature, ranging from, for example, about 600° C. to 1000° C., for a period ranging from several minutes to several hours in an inert atmosphere (e.g., nitrogen, argon, helium, and mixtures thereof). Then, the shaped body may be cooled and removed from the furnace. The process may be repeated one or more times.

In addition, or alternatively, the shaped body may undergo a firing effecting controlled oxidation, referred to herein as “controlled oxidation,” “control oxidation,” and variations thereof. Controlled oxidation may include, for example, activation processes. The process of activation may allow the carbon in a ceramic or carbon-based shaped body to form a microcrystalline structure, wherein the carbon has been processed to produce high porosity. Oxidized or activated carbon may be characterized by a high specific surface area (for example, 300 to 2500 m²/g), which may lead to high adsorptive capability. Traditionally, for example, during activation firing, a ceramic or carbon-based shaped body may be heated in an inert atmosphere (e.g., nitrogen, argon, helium, and mixtures thereof) to a high temperature, ranging from, for example, about 600° C. to 1000° C., and then “soaked” in an oxidizing gas (e.g., carbon dioxide, water, and mixtures thereof) for a few minutes to many hours to activate the carbon in the ceramic or carbon-based shaped body. The process may be repeated one or more times.

According to various exemplary embodiments, the shaped body is set before firing, which may aid in managing the uniformity of the flow of gas and thermal energy. Setting the shaped body may, in certain exemplary embodiments, comprise placing the shaped body in a furnace configured to allow the reacting gases to uniformly flow through all the channels of the shaped body and protecting the exposed sides of the shaped body placing the shaped body. In additional exemplary embodiments, setting may comprise placing the shaped body on at least one diffuser box and protecting the exposed sides of the shaped body. In one exemplary embodiment, setting may also include the use of at least one setter and/or cookie. In at least one exemplary embodiment, a “cookie” may be a thin slice of material, such as a thin slice of a ceramic, inorganic cement, or carbon-based honeycomb body. In at least one further exemplary embodiment, a “setter” may be an apparatus, such as a slab, on which the shaped body is mounted for firing. The setter may, in one embodiment, be of the same material as the shaped body which is being fired. In various additional embodiments, the shaped body may be on a setter, which may be on at least one diffuser box.

In various exemplary embodiments, protecting the shaped body's exposed sides may reduce excessive oxidation of the shaped body's skin, entrance, and/or exit areas of the channels. As used herein, “protecting” the shaped body's exposed sides, and variations thereof, is intended to mean physically covering the exposed sides of the shaped body and/or controlling the processes gases in a manner such that excessive oxidation does not occur on the exposed sides, e.g., limiting the amount of process gas flowing through the shaped body such that the gases exiting the shaped body are substantially reacted. Protecting the shaped body's exposed sides may, in certain embodiments, be desirable because excessive oxidation can cause weaknesses in certain structures. Thus, these areas may be protected with materials such as, but not limited to, cookies, ceramic felt, and/or any other material known to those of skill in the art. According to one exemplary embodiment, the exposed sides of the shaped body are protected with ceramic felt. In another exemplary embodiment of the invention, the side of the shaped body on which the gas exits is protected with a cookie. In another exemplary embodiment, the sides of the shaped body are protected by a metal sleeve.

The setter configuration may be vertical, horizontal, or even diagonal. The diffuser box and a setter or cookie may, in various embodiments, be placed on the surface of the shaped body where the gas flow is introduced, and may be placed on both sides of the shaped body if gas flows in both directions through the shaped body.

According to various embodiments, the configuration containing the shaped body may then be placed in an apparatus for firing, such as a furnace. By way of example only, the furnace may be a small retort chamber or a large retort chamber. The furnace door may then be closed, and the structure may be fired. Firing may be done by any method known to those of skill in the art. According to various exemplary embodiments, firing may comprise heating the structure, and may optionally further comprise flowing at least one inert or oxidizing gas through the structure. The structure may be fired to achieve heat treatment and/or oxidation of the shaped body.

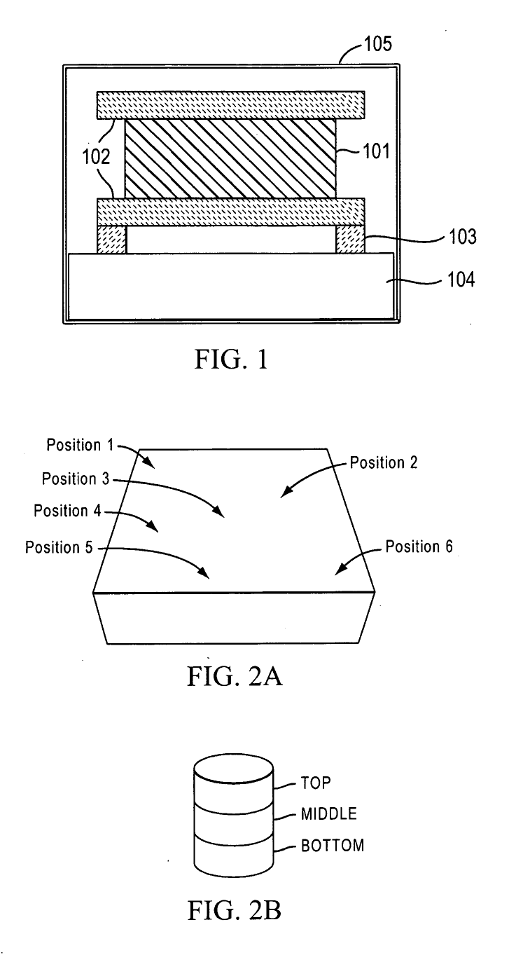

FIG. 1 illustrates an exemplary embodiment of the setter configuration. The shaped body 101 is placed on a cookie 102 and another cookie 102 is placed on top of the shaped body. In the exemplary embodiment of FIG. 1, the shaped body/cookie combination rests upon a 1″ cookie with a hole (or a setter) 103 and a diffuser box 104. The setter configuration in FIG. 1 is placed inside a retort furnace 105.

According to one exemplary embodiment, the shaped body may be fired by heating with process gas flow. The amount of process gas flow through the shaped body may, for example, be adjusted by input gas flow rates and/or amount of exhaust gas vented. By way of example, with reference to the embodiment depicted in FIG. 1, exhaust gas flow from the retort chamber can be vented or piped directly to exhaust ports on the retort chamber. As a further example, valving can be conducted on one or more exhaust ports on the furnace chamber.

In addition, in certain embodiments, process gas flow temperature may be controlled by managing the furnace ramp rate. Managing the ramp rate in relation to material expansion properties may achieve a substantially crack-free shaped body with high oxidized surface area by controlling thermal expansion/shrinkage changes during the process cycle.

The appropriate temperature, furnace ramp rate, process gas flow rate, and/or length of soaking in the process gas(es) may easily be determined by those of skill in the art, and may be determined at least in part based upon the properties desired in the final product. For example, process temperatures up to 1000° C. may be used, with gas soak times often ranging from a few minutes to many hours. In addition, the temperature, furnace ramp rate, process gas flow rate, and/or length of soaking may be dependent upon one another. For example, when the temperature of the firing or gas flow rate is higher, the length of soaking may be shorter, or when the temperature or gas flow rate is lower, the length of soaking may be greater, etc. One of skill in the art may, in certain embodiments, choose the temperature, length of firing, and soak time based upon other variables as well, and these determinations are well within the ability of those skilled in the art to make.

In one exemplary embodiment, the shaped body is a ceramic, inorganic cement, or carbon-based body that may be set and the firing may include at least one heat treatment cycle, such as a carbonization cycle. In at least one embodiment, the ramp rate may be controlled, for example in a manner that minimizes the thermal stresses during the cycle. For carbonization, an inert gas, such as nitrogen, may be used in the firing process at lower temperatures, even less than 500° C., in at least one embodiment. In further embodiments, carbonization may occur at greater temperatures, such as, for example, up to about 800-900° C. or even higher. The gas flow rate during carbonization may, in various embodiments, range from 1 to 100 scfh or more, and in one embodiment of the disclosure, the flow rate ranges from 1 to 15 scfh, and in another, it ranges from 5 to 15 scfh. The ramp rate during carbonization may range from, for example, 0.1 to 5° C./minute or more in various exemplary embodiments. In one embodiment, the ramp rate for carbonization is about 1° C./minute and in another about 2° C./minute. In various exemplary embodiments, the hold time for carbonization may range from a few minutes to several hours, and in one embodiment the hold time may be about 2 hours or more.

In one exemplary embodiment, the shaped body is a ceramic, inorganic cement, or carbon-based body that may be subjected to at least one controlled oxidation process, such as at least one activation process. By way of example only, the structure may be activated using at least one oxidizing or activating gas at an elevated temperature, for example greater than 500° C., such as greater than 800° C. or even higher. In one embodiment of the present disclosure, the activation temperature is about 840° C. Non-limiting examples of the oxidizing gas that may be used in various embodiments of the invention include carbon dioxide and mixtures of carbon dioxide and nitrogen. In one aspect of the disclosure, carbon dioxide is used and the activation process is an endothermic reaction represented by the following equation (1):

Cs+CO2→2CO (1)

In various exemplary embodiments, the oxidizing gas flow rate during the controlled oxidation process, such as activation, may range from 1 to 100 scfh or more, and in one embodiment the flow rate may range from 1 to 15 scfh or from 5 to 15 scfh. The ramp rate during oxidation may range from 0.1 to 5° C./minute or more in various exemplary embodiments. For example, in one embodiment of the present disclosure, the ramp rate for oxidation is about 1° C./minute, and in another embodiment about 2° C./minute. The soak time or hold time in the oxidizing gas may range from a few minutes to several hours in various exemplary embodiments, such as, for example 30 minutes to 16 hours, 1 to 10 hours, or even 1 to 6 hours. In one embodiment the total oxidation time (ramp time and soak/hold time) may range from 1 to 30 hours, 5 to 25 hours, or even 10 to 20 hours.

In at least one additional exemplary embodiment, the methods comprise heat treatment and/or controlled oxidation of at least one honeycomb shaped body, wherein the process gas flows through the multiplicity of cells or channels of the honeycomb body from the inlet end to the outlet end.

Because the retort door is generally cooled with water, the front of the shaped body may be a few degrees cooler than the rest of the shaped body, and may change the reaction kinetics. This may result in lower oxidation at the front of the sample. Additionally, for example in relation to a ceramic, inorganic cement, or carbon-based honeycomb body, the reaction rate is higher at the oxidizing gas entrance to the ceramic, inorganic cement, or carbon-based honeycomb structure than the remaining length of the channel. Thus after one oxidation or activation cycle, a ceramic, inorganic cement, or carbon-based honeycomb body may be flipped, rotated, and oxidized/activated again to facilitate substantially uniform activity.

Both the oxidizing gas flow and the temperature are managed to achieve the desired oxidation level. Carbon burn off is an indicator of oxidation of a carbon-based and/or ceramic shaped body, i.e., activation, and is referred to herein as “burn off on activation” or “BOA,” and variations thereof. The surface area of an activated ceramic or carbon-based body also changes upon activation. Highly activated carbon catalysts may have a surface area greater than 700 m²/g. Thus, controlled oxidation processes may be important in achieving high surface area with physical integrity.

Optionally, in certain embodiments, both heat treatment and controlled oxidation may be combined in one single cycle to achieve an oxidized product. This may be desirable in various embodiments, such as to reduce the heating cycles and total processing time.

As stated previously, the process may be executed in a vertical, horizontal, or diagonal arrangement. In one aspect of the present disclosure, the arrangement is a horizontal configuration with process gas and heat flow from either left or right side, or both. Such a horizontal flow configuration may be advantageous for managing both heat treatment and controlled oxidation steps for longer samples, for example, those greater than 12 inches in length.

The methods of the present disclosure may, for example, make it possible to achieve substantially uniform activation of a ceramic, inorganic cement, or carbon-based body with high surface area, for example 700 m²/g or more, and with high modulus of rupture “MOR” strength, for example 300 psi or more.

Unless otherwise indicated, all numbers used in the specification and claims are to be understood as being modified in all instances by the term “about,” whether or not so stated. It should also be understood that the precise numerical values used in the specification and claims form additional embodiments of the invention. Efforts have been made to ensure the accuracy of the numerical values disclosed in the Examples. Any measured numerical value, however, can inherently contain certain errors resulting from the standard deviation found in its respective measuring technique.

As used herein the use of “the,” “a,” or “an” means “at least one,” and should not be limited to “only one” unless explicitly indicated to the contrary.

Other embodiments of the invention will be apparent to those skilled in the art from consideration of the specification and practice of the invention disclosed herein. It is intended that the specification and examples be considered as exemplary only, with a true scope and spirit of the invention being indicated by the claims.

### EXAMPLES

The following examples are not intended to be limiting of the invention as claimed.

### Example 1

An 8″×8″×2″ shaped body in the form of a honeycomb having a 100/17 cell structure was prepared with one heat treatment cycle, i.e., carbonization cycle, and two controlled oxidation cycles, i.e., activation cycles, as follows:

The shaped body was placed on a ceramic honeycomb setter and diffuser box and covered with ceramic felt with a cookie on the top. The configuration was placed inside a retort furnace. The shaped body was carbonized by flowing nitrogen through the body at a rate of 100 scfh and a ramp rate of 2° C./minute up to a temperature of 840° C., where it was held for 2 hours. The shaped body was cooled to 65° C. and removed.

The configuration was then placed in another retort furnace for activation. For the first activation cycle, carbon dioxide was flowed through the honeycomb structure at a rate of 3 scfh and a ramp rate of 2° C./minute to a temperature of 840° C. and held for a soak time of 9 hours. The shaped body was cooled to 65° C. and flipped and rotated in the retort. The shaped body was fired a second time under the same conditions. Upon completion of the second activation firing, the shaped body was cooled and removed.

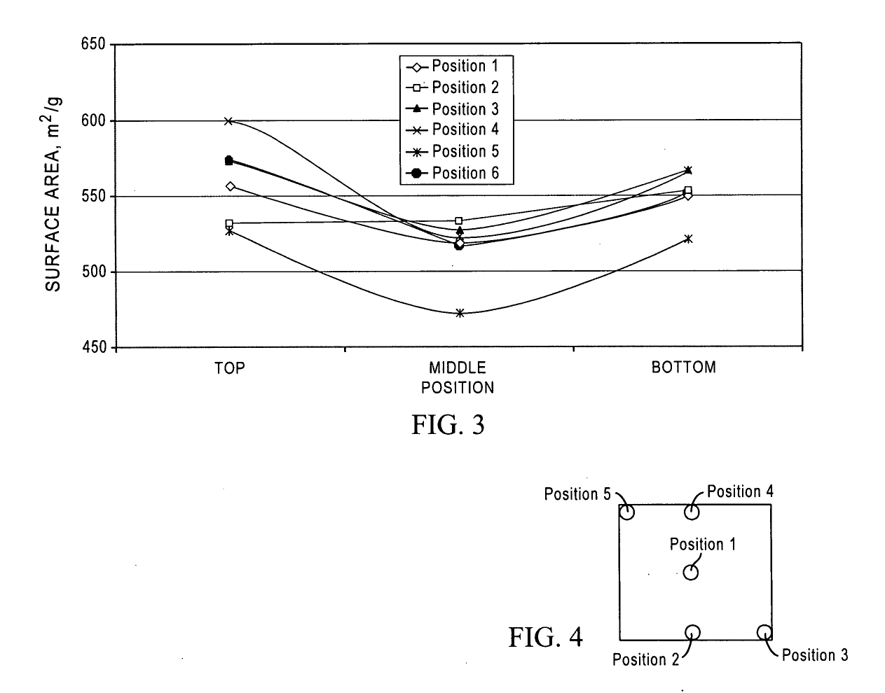

FIG. 2A depicts detailed surface area mapping for the 8″×8″×2″ activated sample. The surface area was measured at points 1-6 at the top, middle, and bottom of the core taken from the shaped body, as depicted in FIG. 2B. FIG. 3 depicts the surface areas obtained at these points. As seen from FIG. 3, the method produced a substantially uniformly active shaped body.

### Example 2

An 8″×8″×3″ shaped body in the form of a honeycomb having a 100/17 cell structure was prepared with one heat treatment cycle, i.e., carbonization cycle, and two controlled oxidation cycles, i.e., activation cycles, as set forth in Example 1. The method was repeated with four more samples, for a total of five samples.

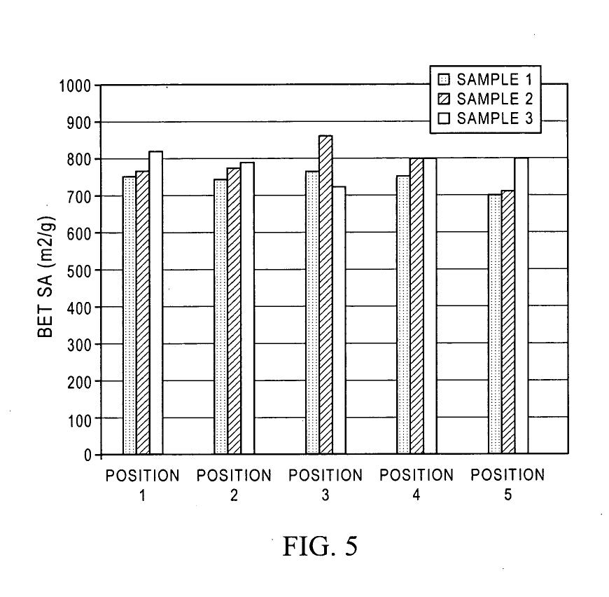

FIG. 4 depicts detailed surface area mapping for the 8″×8″×3″ activated samples. The surface areas were measured at points 1-5, by taking a small core at each point and crushing it for analysis. FIG. 5 depicts the surface areas obtained at the five points for samples 1-3 of this example. As seen from FIG. 5, the method produced a substantially uniformly active shaped body.

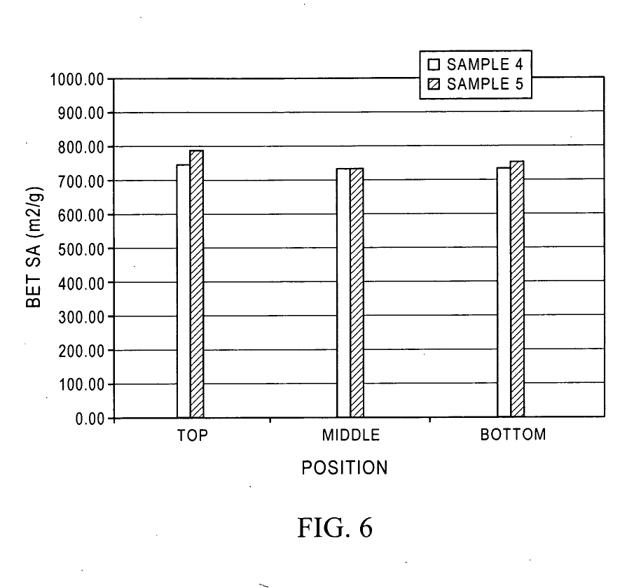

Core samples were also selected from mapped position 1 in FIG. 4 of samples 4 and 5, which were cut into three parts, top, middle, and bottom, as depicted in FIG. 2B. FIG. 6 depicts the surface areas obtained at these points. FIG. 6 also shows that the method produced a substantially uniformly active shaped body.

### Example 3

An 8″×8″×3″ shaped body in the form of a honeycomb having a 100/17 cell structure was prepared with one heat treatment cycle, i.e., carbonization cycle, and one controlled oxidation cycle, i.e., activation cycle, as follows:

The shaped body was carbonized as described in Example 1.

The configuration was then placed in another retort furnace for activation. For the activation cycle, carbon dioxide (5 scfh) and nitrogen (15 schf) and diluent gas was flowed through the honeycomb structure, and the temperature was ramped at a rate of 2° C./minute to a temperature of 800° C. and held for a soak time of 16 hours. The shaped body was cooled to 65° C. and removed.

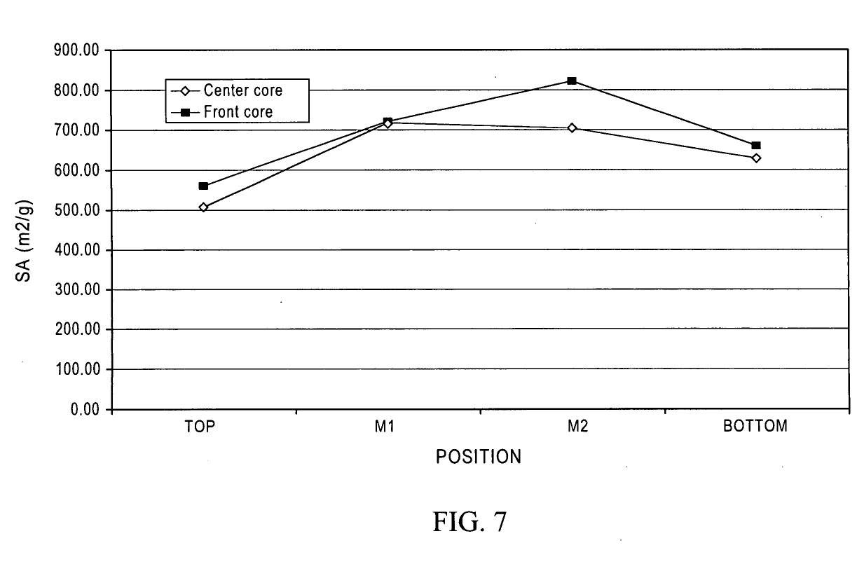

FIG. 7 depicts the surface areas measured at four points (top, middle 1, middle 2, and bottom) of the center core and front core of the shaped body. As expected, FIG. 7 demonstrates that there is excessive activation at the shaped body entrance and surface area changes as a function of channel length. However, the results also demonstrate the feasibility of a single activation cycle.

The method was repeated using three more samples (Samples 2-4) and varying the conditions as set forth in Table 1 below.

TABLE 1

| | | | Soak | | Weight |
|---|---|---|---|---|---|
| Sample | CO2 Flow | N2 flow (scfh) | Time | | loss |
| No. | Rate (SCFH) | during soak | (h) | Temp. (° C.) | (% BOA) |
| 2 | 3 | 9 | 22 | 840 | 34.1492 |
| 3 | 3 | 30 | 22 | 840 | 33.7597 |
| 4 | 3 | 150 | 22 | 840 | 37.1767 |

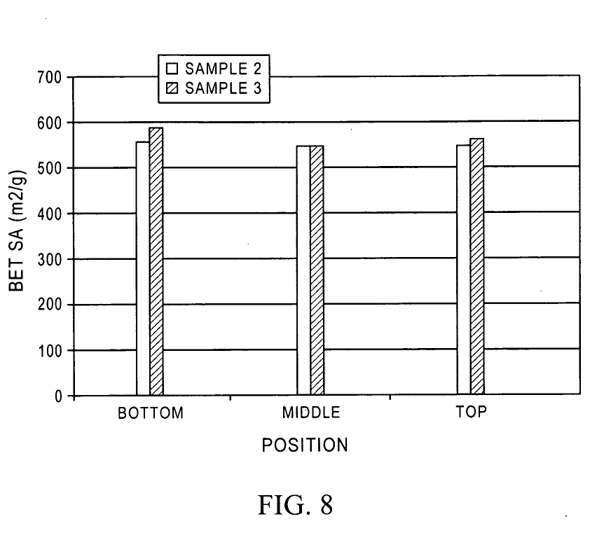

FIG. 8 depicts the surface areas measured at 3 points (top, middle, and bottom) of the center core of Samples 2 and 3. FIG. 8 demonstrates that there is substantially uniform activation and further demonstrates the feasibility of a single activation cycle.

### Example 4

Several shaped bodies in the forms of honeycombs were prepared with one heat treatment cycle, i.e., carbonization cycle, and one or two controlled oxidation cycles, i.e., activation cycles, as follows:

The shaped body was placed on a ceramic honeycomb setter and diffuser box and covered with ceramic felt with a cookie on the top. The configuration was placed inside a retort furnace. The shaped body was carbonized by flowing nitrogen through the body at a rate of 100 scfh and a ramp rate of 2° C./minute up to a temperature of 840° C., where it was held for 2 hours. The shaped body was cooled to 65° C. and removed.

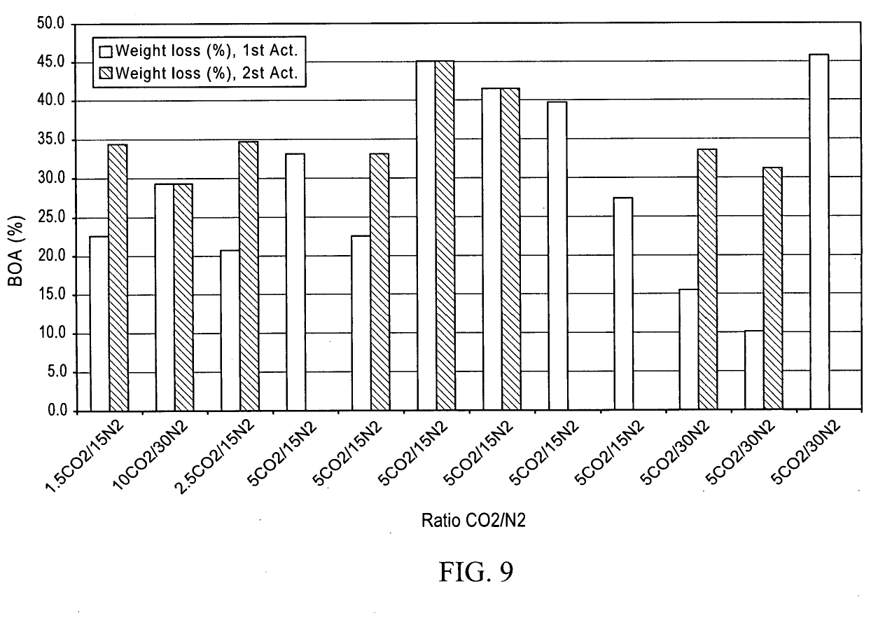

The configuration was then placed in another retort furnace for at least one activation cycle. For the at least one activation cycle, a mixture of carbon dioxide and nitrogen in the ratio set forth in the table of FIG. 9 was flowed through the honeycomb structure at a rate of 3 scfh and a ramp rate of 2° C./minute to a temperature of 800° C. and held for a period ranging from 10-16 hours depending upon the sample. The shaped body was cooled.

In some instances, as indicated by a second bar for a given activation gas ratio in FIG. 9, the shaped body was further activated in a second cycle. For the second cycle, the shaped body was flipped and rotated in the retort. The shaped body was fired a second time under the same conditions. Upon completion of the second activation firing, the shaped body was cooled and removed.

FIG. 9 depicts detailed BOA for each activation cycle as a function of the carbon dioxide/nitrogen ratio in the reaction gas.

### Example 5

Various shaped bodies in the forms of honeycombs having a 100/17 cell structure were prepared with one heat treatment cycle, i.e., carbonization cycle, and two controlled oxidation cycles, i.e., activation cycles, as follows:

The shaped body was placed on a ceramic honeycomb setter and diffuser box and covered with ceramic felt with a cookie on the top. The configuration was placed inside a retort furnace. The shaped body was carbonized by flowing nitrogen through the body at a rate of 100 scfh and a ramp rate of 2° C./minute up to a temperature of 400° C., and then at a rate of 1 ° C./minute up to a temperature of 840° C. where it was held for 2 hours. The shaped body was cooled to 65 ° C. and removed.

The configuration was then placed in another retort furnace for activation and fired under the conditions set forth in Table 2 below.

Sample 9 in Table 2, however, was run with an all-in-one-cycle (including carbonization and activation) with a CO₂ soak time of 11 hrs at a temperature of 820° C. with CO₂ flow of 5 scfh and N₂ flow of 15 scfh. The sample was exposed to CO₂ gas during the carbonization period (the initial temperature ramp to 840° C. and hold time of 5 hrs).

Table 2 shows the resulting surface areas and burn off on activation for the samples. Most of the samples have surface areas of greater than 700 m²/g of surface area and MOR greater than 100 psi. As seen in Table 2, sample 9, the single cycle sample, has the highest burn off on activation of 45.8%, which is attributed to the CO₂ reaction during the carbonization cycle. There was excessive activation on gas entrance and on all sides. This demonstrates the feasibility of all-in-one-cycle to effectively process both carbonization and activation steps continuously.

TABLE 2

| | | | | | | BET SA | |
|---|---|---|---|---|---|---|---|
| Sample | Ramp rate | CO₂ flow | Act. Temp | Total Act. | | (m²/g) | MOR |
| Number | (° C./min) | (scfh) | (° C.) | Time (h) | BOA | center core | Axial psi |
| 1 | 2 | 3 | 840 | 18.5 | 34.1 | 771.2 | 324 |
| 2 | 2 | 3 | 840 | 16.5 | 34.3 | 784.8 | |
| 3 | 2 | 3 | 840 | 18 | 34 | 740.71 | 580 |
| 4 | 2 | 3 | 840 | 17 | 33.6 | 687.3 | |
| 5 | 2 | 3 | 840 | 16 | 33.7 | 785.7 | |
| 6 | 2 | 3 | 840 | 18 | 34.2 | 746.81 | 173 |
| 7 | 2 | 3 | 840 | 19.0 | 34 | 756 | |
| 8 | 2 | 3 | 840 | 18.5 | 36.6 | 776 | 104 |
| 9 | 2 | 3 | 820 | 11.0 | 45.8 | | |
| 10 | 2 | 3 | 840 | 17.0 | 33.7 | 790 | |

What is claimed is:

1. A method for heat treatment and/or controlled oxidation of at least one shaped body, comprising setting at least one shaped body and firing the at least one shaped body in a furnace;
wherein setting the at least one shaped body comprises placing the shaped body in a furnace configured to allow the reacting gases to uniformly flow through all the channels of the shaped body and protecting the exposed sides of the shaped body.

2. The method of claim 1, wherein the firing is chosen from at least one heat treatment cycle, at least one controlled oxidation cycle, and combinations thereof.

3. The method of claim 2, wherein the at least one heat treatment cycle is a carbonization cycle.

4. The method of claim 2, wherein the at least controlled oxidation cycle is an activation cycle.

5. The method of claim 1, wherein the firing comprises at least one heat treatment cycle and at least two controlled oxidation cycles.

6. The method of claim 1, wherein the firing comprises at least one combined heat treatment and controlled oxidation cycle.

7. The method of claim 1, wherein the firing comprises at least one heat treatment cycle, wherein the process gas flow for the heat treatment cycle comprises nitrogen.

8. The method of claim 1, wherein the firing comprises at least one controlled oxidation cycle, wherein the process gas flow for the controlled oxidation cycle comprises carbon dioxide and/or steam.

9. The method of claim 8, wherein the process gas flow further comprises nitrogen.

10. The method of claim 1, wherein the shaped body is a ceramic, inorganic cement, or carbon-based body.

11. The method of claim 10, where in the at least one ceramic, inorganic cement, or carbon-based body is a honeycomb body.

12. The method of claim 1, wherein setting the at least one shaped body further comprises placing the at least one shaped body on at least one diffuser box.

13. The method of claim 12, wherein setting the at least one shaped body further comprises placing the at least one shaped body on at least one setter or cookie before being placing the at least one shaped body on at least one diffuser box.

14. The method of claim 1, wherein setting the at least one shaped body further comprises suspending the shaped body in the furnace using at least one metal sleeve.

15. The method of claim 1, wherein protecting the exposed sides of the shaped body comprises covering the exposed sides with cookies and/or ceramic felt.

16. The method of claim 1, wherein protecting the exposed sides of the shaped body comprises covering the exposed sides with at least one metal sleeve.

17. The method of claim 1, wherein said method further comprises the step of managing the furnace ramp rate.

18. The method of claim 1, wherein the firing comprises at least one heat treatment cycle and at least two controlled oxidation cycles, and wherein setting the at least one shaped body comprises:
placing the shaped body on at least one cookie, which is on top of at least one setter, which is on top of at least one diffuser box,
protecting the top of the shaped body with a cookie,
and protecting the remaining exposed sides of the shaped body with ceramic felt.

19. A method for heat treatment and/or controlled oxidation of at least one shaped body, comprising setting at least one shaped body and firing the at least one shaped body in a furnace;
wherein the at least one shaped body is comprised of carbon-based materials; and
wherein setting the at least one shaped body comprises placing the shaped body in a furnace configured to allow the reacting gases to uniformly flow through all the channels of the shaped body.

20. A carbon-based body having substantially uniform activation obtained by setting at least one carbon-based body and uniformly firing the at least one carbon-based body;
wherein setting the at least one carbon-based body comprises placing the carbon-based body in a furnace configured to allow the reacting gases to uniformly flow through all the channels of the carbon-based body and protecting the exposed sides of the carbon-based body.
